(19) United States
(12) Patent Application Publication
(10) Pub. No.: US 2023/0422232 A1
(43) Pub. Date: Dec. 28, 2023

(54) SCHEDULING BEAMFORMING COMMUNICATIONS BASED ON A NUMBER OF COMMUNICATION DEVICES IN EACH BEAM

(71) Applicant: Telefonaktiebolaget LM Ericsson (publ), Stockholm (SE)

(72) Inventor: Zaigham KAZMI, Austin, TX (US)

(21) Appl. No.: 18/039,007

(22) PCT Filed: Dec. 17, 2020
(86) PCT No.: PCT/IB2020/062148

§ 371 Date: May 26, 2023

(51) Int. Cl. H04W 72/044; H04W 72/02; H04W 72/12; H04W 72/566

(52) U.S. Cl. CPC H04W 72/046; H04W 72/02; H04W 72/12; H04W 72/566

(57) ABSTRACT

A network node configured to communicate with a plurality of communication devices in a communications network via a plurality of beams can schedule communications based on the number of communication devices in each beam. The network node can determine a number of communication devices of the plurality of communication devices that are in a beam of the plurality of beams. The network node can determine a scheduling priority of a communication device of the plurality of communication devices based on the number of communication devices that are in the beam, the communication device being in the beam. The network node can select the beam based on the scheduling priority of the communication device. The network node can, responsive to selecting the beam, schedule communication with the communication device via the beam.

### TECHNICAL FIELD

The present disclosure relates generally to communications, and more particularly to communication methods and related devices and nodes supporting scheduling beamforming communications based on a number of communication devices in each beam.

### BACKGROUND

FIG. 1 illustrates an example of a 5th Generation (“5G”) network (also referred to as a new radio (“NR”) network) including a network node 110 (e.g., a 5G base station (“gNB”)), multiple communication devices 120 (also referred to as user equipment (“UE”)).

In new radio (“NR”) high band (“FR2”), analog beam forming can be used. Analog beam forming can include only a few beams (e.g., of the order of ones) being formed at any given time (e.g., during a slot or a mini slot). This can restrict scheduling in that slot (or mini-slot) to only the users who are within that beam. In some examples, users are restricted to a subset of these beams and other beams are either wasted or underutilized.

### SUMMARY

According to some embodiments, a method of operating a network node configured to communicate with a plurality of communication devices in a communications network via a plurality of beams is provided. The method includes determining a number of communication devices of the plurality of communication devices that are in a beam of the plurality of beams. The method further includes determining a scheduling priority of a communication device of the plurality of communication devices based on the number of communication devices that are in the beam, the communication device being in the beam. The method further includes selecting the beam based on the scheduling priority of the communication device. The method further includes, responsive to selecting the beam, scheduling communication with the communication device via the beam.

In other embodiments, a network node configured to communicate with a plurality of communication devices in a communications network via a plurality of beams is provided. The network node includes processing circuitry and memory coupled to the processing circuitry and having instructions stored therein that are executable by the processing circuitry to cause the network node to perform operations. The operations include determining a number of communication devices of the plurality of communication devices that are in a beam of the plurality of beams. The operations further include determining a scheduling priority of a communication device of the plurality of communication devices based on the number of communication devices that are in the beam, the communication device being in the beam. The operations further include selecting the beam based on the scheduling priority of the communication device. The operations further include, responsive to selecting the beam, scheduling communication with the communication device via the beam.

In other embodiments, a network node configured to communicate with a plurality of communication devices in a communications network via a plurality of beams is provided. The network node is adapted to perform operations. The operations include determining a number of communication devices of the plurality of communication devices that are in a beam of the plurality of beams. The operations further include determining a scheduling priority of a communication device of the plurality of communication devices based on the number of communication devices that are in the beam, the communication device being in the beam. The operations further include selecting the beam based on the scheduling priority of the communication device. The operations further include, responsive to selecting the beam, scheduling communication with the communication device via the beam.

In other embodiments, a computer program is provided. The computer program includes program code to be executed by processing circuitry of a network node configured to communicate with a plurality of communication devices in a communications network via a plurality of beams. Execution of the program code causes the network node to perform operations. The operations include determining a number of communication devices of the plurality of communication devices that are in a beam of the plurality of beams. The operations further include determining a scheduling priority of a communication device of the plurality of communication devices based on the number of communication devices that are in the beam, the communication device being in the beam. The operations further include selecting the beam based on the scheduling priority of the communication device. The operations further include, responsive to selecting the beam, scheduling communication with the communication device via the beam.

In other embodiments, a computer program product is provided. The computer program product includes a non-transitory storage medium including program code to be executed by processing circuitry of a network node configured to communicate with a plurality of communication devices in a communications network via a plurality of beams. Execution of the program code causes the network node to perform operations. The operations include determining a number of communication devices of the plurality of communication devices that are in a beam of the plurality of beams. The operations further include determining a scheduling priority of a communication device of the plurality of communication devices based on the number of communication devices that are in the beam, the communication device being in the beam. The operations further include selecting the beam based on the scheduling priority of the communication device. The operations further include, responsive to selecting the beam, scheduling communication with the communication device via the beam.

Various embodiments described herein schedule data communications based on a number of communication devices in each beam, which can allow for the potential benefit of allowing communication devices (and their associated users) that move around to be scheduled as part of a dense beam as opposed to a sparse beam. Prioritizing dense beams over sparse beams can result in more efficient use of cell resources and can increase overall system throughput. In some examples, the more that users move across beams, the greater the chance that a dense beam will be prioritized over a sparse beam resulting in a more efficient usage of cell resources.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a wireless communications network;

FIG. 2 is a schematic diagram illustrating an example of a wireless communications network in a suburban or residential area according to some embodiments of inventive concepts;

FIG. 3 is a schematic diagram illustrating an example of a wireless communications network in a mixed-use area according to some embodiments of inventive concepts;

FIG. 4 is a graph illustrating an example of a throughput per time unit of a wireless communications network using a legacy scheduling procedure (“LOpt-1”) according to some embodiments of inventive concepts;

FIG. 5 is a graph illustrating an example of a throughput per time unit of a wireless communications network using a beam-user-based (“BUB”) scheduling procedure according to some embodiments of inventive concepts;

FIG. 6 is a graph illustrating an example of a difference in throughput per time unit between a wireless communications network using a BUB scheduling procedure and a LOpt-1 according to some embodiments of inventive concepts;

FIG. 7 is a graph illustrating an example of maximum delay and average delay experienced by users in a wireless communications network when using a BUB scheduling procedure and maximum delay and average delay experienced by users in a wireless communications network when using a LOpt-1 according to some embodiments of inventive concepts;

FIG. 8 is a flow chart illustrating an example of operations performed in a BUB scheduling procedure according to some embodiments of inventive concepts;

FIG. 9 is a block diagram illustrating a wireless device (“UE”) according to some embodiments of inventive concepts;

FIG. 10 is a block diagram illustrating a radio access network (“RAN”) node according to some embodiments of inventive concepts;

FIG. 11 is a block diagram illustrating a CN (“CN”) node according to some embodiments of inventive concepts;

FIGS. 12-14 are flow charts illustrating examples of operations of a UE according to some embodiments of inventive concepts;

FIG. 15 is a block diagram of a wireless network in accordance with some embodiments; and

FIG. 16 is a block diagram of a user equipment in accordance with some embodiments.

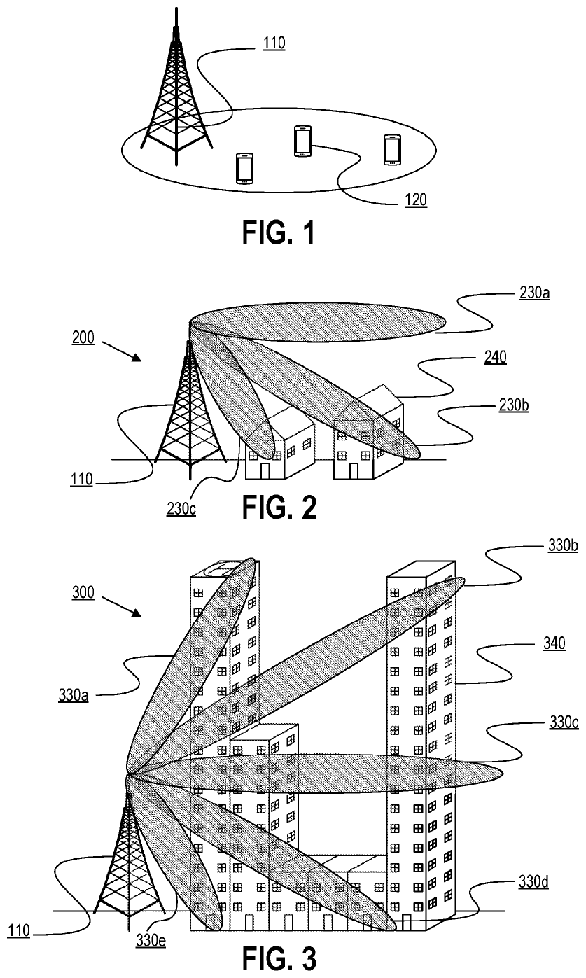

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

FIG. 2 illustrates an example of a wireless communications network 200 in a suburban or residential area with houses 240. In this example, the network node 110 communicates with communication devices in the communications network 200 via beams 230a-c. The communication devices can include mobile devices associated with individuals in or around the houses 240. As illustrated, some of the beams (e.g., beam 230a) may be elevated such that fewer (or no) communication devices are included in the beam. These beams may be considered as wasted or underutilized.

FIG. 3 illustrates an example of a wireless communications network 300 in an urban or mixed-use area with office buildings 340. In this example, the network node 110 communicates with communication devices in the communication network 300 via beams 330a-e. People can move around to different floors of the office buildings 340 such that there are a different number of people (and communication devices) on different floors at different times of the day. For example, most floors may be occupied during office hours but empty during the night. Furthermore, more people may be present on streets and/or in restaurants and bars at ground level during the night. Even during the daytime, many users may be concentrated in one or two floors that have a cafeteria during lunchtime. Given that some communication devices include mobile devices associated with individuals, some of beams 330a-e may include more communication devices than others at different parts of the day. Furthermore, some of beams 330a-e may be considered as wasted or underutilized during specific times of the day.

In cellular wireless communication (e.g., long term evolution (“LTE”) and new radio (“NR”)), a user equipment (“UE”) can be scheduled by a radio access network (“RAN”) node for both uplink and downlink data transmission. A number of different scheduling procedures exist with different goals: to maximize cell throughput, to meet users' guaranteed throughput, to optimize overall throughput etc. These scheduling procedures take into account different parameters for example, users' signal-to-interference and noise ratio (“SI NR”), users' quality of service (“QoS”) requirements, and cell bandwidth. However, these procedures don't consider users' location.

In some examples, broadcast beams (e.g., synchronized signal blocks (“SSBs”)) will be swept through entire coverage area irrespective of whether there are users within a given coverage location or not.

In additional or alternative examples, traffic beams that carry user specific control and data information, don't consider number of users in the coverage of a given beam. However, by virtue of targeting connected users they do prioritize beams with users over beams that have no users.

In additional or alternative examples, a scheduling procedure adjusts downlink (“DL”)/uplink (“UL”) transmission resources are according to buffer status and for controlling inter-cell interference, however, the scheduling procedure does not consider how many UEs are in the given beam.

In additional or alternative examples, a scheduling procedure uses priority rules for selecting a time division multiplexing (“TDM”) pattern, but does not consider a number of users in a given beam.

In additional or alternative examples, a scheduling procedure targets a group of users by using beam-sweeping as in transmission of common control information (e.g., SSB).

In additional or alternative examples, a scheduling procedure considers interference caused by neighboring base stations and/or UEs in the neighboring cells, but does not consider a number of users in a given beam.

Various embodiments described herein include performing a scheduling decision based on a number of users (or UEs), Nbeam_user, in a given beam. In some embodiments, Nbeam_user is the number of users in a given beam that have data to be scheduled. In additional or alternative embodiments, a weight, Wbeam_user, that is proportional to Nbeam_user is added to an overall scheduling matrix so that a beam with more users is prioritized over a beam with fewer users.

In some embodiments, a scheduling procedure based on Nbeam_user is a proportionally-fair scheme. In additional or alternative embodiments, the prioritization based on Nbeam_user is temporary in the sense that a beam with more users is not always prioritized over other beams with fewer users. In additional or alternative embodiments, Wbeam_user can be selected so that the users in beams with much fewer users are not starved. In some examples, users with higher QoS requirements in sparse beams (beams with fewer users) can be prioritized over users in dense beam (beams with more users). In additional or alternative examples, users who have been waiting longer will be prioritized over users in dense beams.

A potential benefit of scheduling data communications based on a number of communication devices in each beam includes allowing communication devices (and their associated users) that move around to be scheduled as part of a dense beam as opposed to a sparse beam. Prioritizing dense beams over sparse beams can result in more efficient use of cell resources and can increase overall system throughput. In some examples, the more that users move across beams, the greater the chance that a dense beam will be prioritized over a sparse beam resulting in a more efficient usage of cell resources.

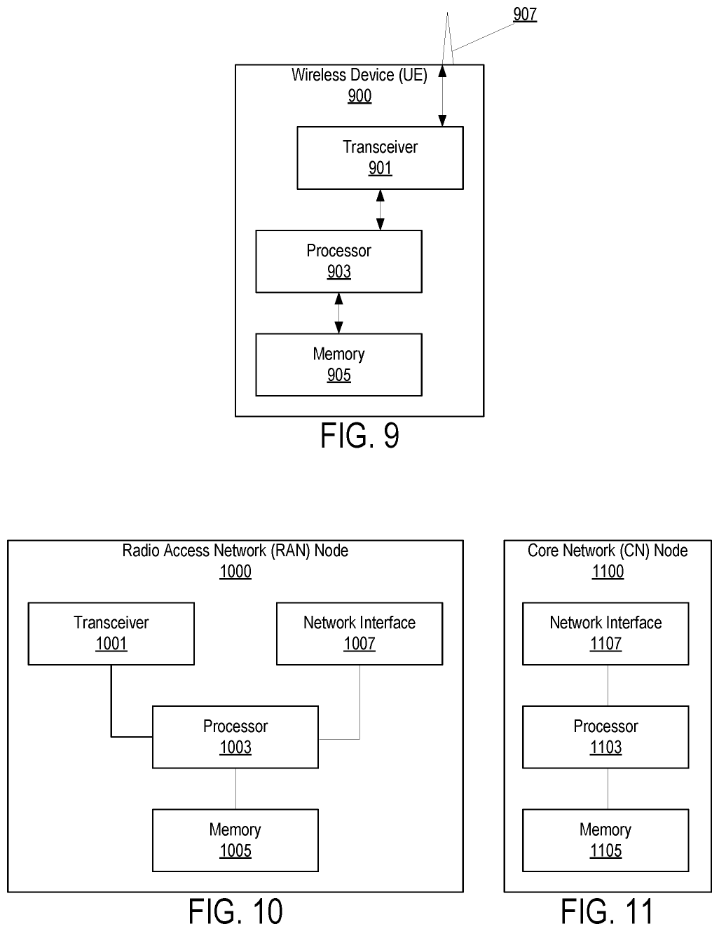

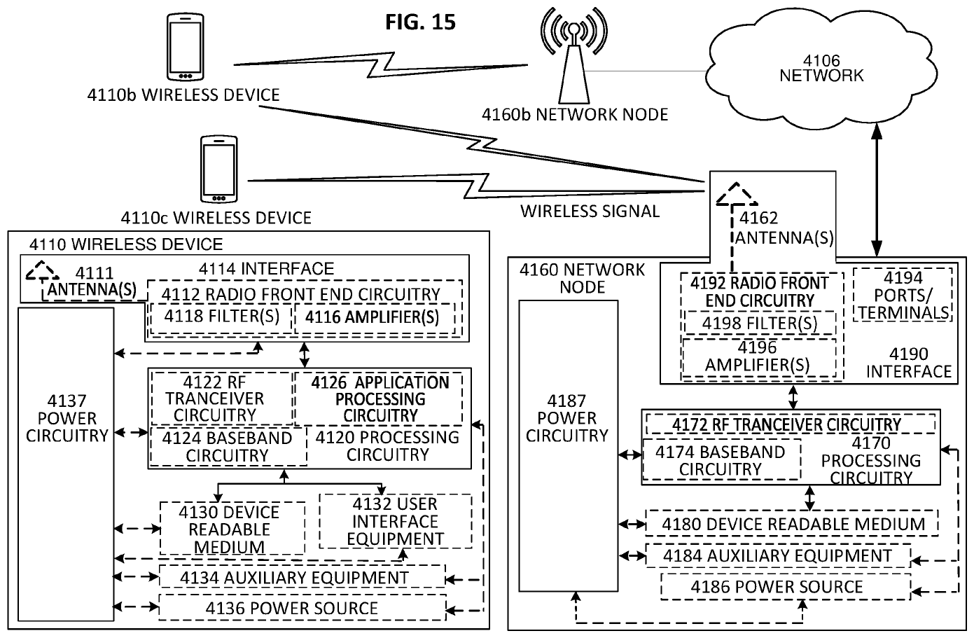

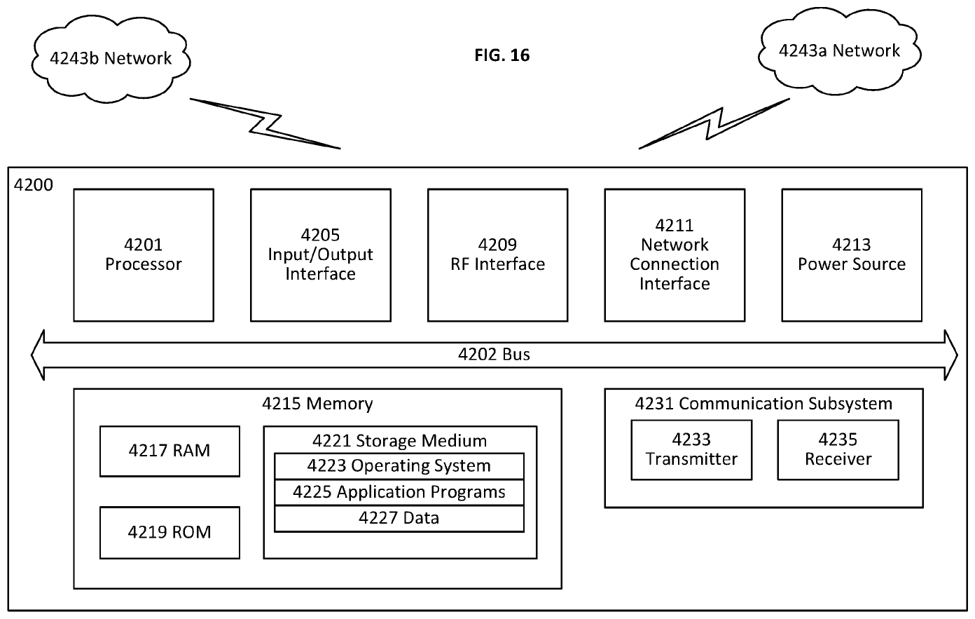

FIG. 9 is a block diagram illustrating elements of a wireless device 900 (also referred to as a mobile terminal, a mobile communication terminal, a wireless communication device, a wireless terminal, mobile device, a wireless communication terminal, a user equipment (“UE”), a user equipment node/terminal/device, etc.) configured to provide wireless communication according to embodiments of inventive concepts. (Wireless device 900 may be provided, for example, as discussed below with respect to wireless device 4110 of FIG. 15, and UE 4200 of FIG. 16.) As shown, wireless device UE may include an antenna 907 (e.g., corresponding to antenna 4111 of FIG. 15), and transceiver circuitry 901 (also referred to as a transceiver, e.g., corresponding to interface 4114 of FIG. 15; and interfaces 4205, 4209, 4211, transmitter 4233, and receiver 4235 of FIG. 16) including a transmitter and a receiver configured to provide uplink and downlink radio communications with a base station(s) (e.g., corresponding to network node 4160 of FIG. 15, also referred to as a RAN node) of a radio access network. Wireless device UE may also include processing circuitry 903 (also referred to as a processor, e.g., corresponding to processing circuitry 4120 of FIG. 15, and processor 4201 of FIG. 16) coupled to the transceiver circuitry, and memory circuitry 905 (also referred to as memory, e.g., corresponding to device readable medium 4130 of FIG. 15) coupled to the processing circuitry. The memory circuitry 905 may include computer readable program code that when executed by the processing circuitry 903 causes the processing circuitry to perform operations according to embodiments disclosed herein. According to other embodiments, processing circuitry 903 may be defined to include memory so that separate memory circuitry is not required. Wireless device UE may also include an interface (such as a user interface) coupled with processing circuitry 903, and/or wireless device UE may be incorporated in a vehicle.

As discussed herein, operations of wireless device UE may be performed by processing circuitry 903 and/or transceiver circuitry 901. For example, processing circuitry 903 may control transceiver circuitry 901 to transmit communications through transceiver circuitry 901 over a radio interface to a radio access network node (also referred to as a base station) and/or to receive communications through transceiver circuitry 901 from a RAN node over a radio interface. Moreover, modules may be stored in memory circuitry 905, and these modules may provide instructions so that when instructions of a module are executed by processing circuitry 903, processing circuitry 903 performs respective operations (e.g., operations discussed below with respect to some embodiments relating to wireless devices).

FIG. 10 is a block diagram illustrating elements of a radio access network RAN node 1000 (also referred to as a network node, base station, eNodeB/eNB, gNodeB/gNB, etc.) of a Radio Access Network (“RAN”) configured to provide cellular communication according to embodiments of inventive concepts. (RAN node 1000 may be provided, for example, as discussed below with respect to network node 4160 of FIG. 15, which should be considered interchangeable in the examples and embodiments described herein and be within the intended scope of this disclosure, unless otherwise noted) As shown, the RAN node may include transceiver circuitry 1001 (also referred to as a transceiver, e.g., corresponding to portions of interface 4190 of FIG. 15) including a transmitter and a receiver configured to provide uplink and downlink radio communications with mobile terminals. The RAN node may include network interface circuitry 1007 (also referred to as a network interface, e.g., corresponding to portions of interface 4190 of FIG. 15) configured to provide communications with other nodes (e.g., with other base stations) of the RAN and/or core network CN. The network node may also include processing circuitry 1003 (also referred to as a processor, e.g., corresponding to processing circuitry 4170 of FIG. 15) coupled to the transceiver circuitry, and memory circuitry 1005 (also referred to as memory, e.g., corresponding to device readable medium 4180 of FIG. 15) coupled to the processing circuitry. The memory circuitry 1005 may include computer readable program code that when executed by the processing circuitry 1003 causes the processing circuitry to perform operations according to embodiments disclosed herein. According to other embodiments, processing circuitry 1003 may be defined to include memory so that a separate memory circuitry is not required.

As discussed herein, operations of the RAN node may be performed by processing circuitry 1003, network interface 1007, and/or transceiver 1001. For example, processing circuitry 1003 may control transceiver 1001 to transmit downlink communications through transceiver 1001 over a radio interface to one or more mobile terminals or mobile UEs and/or to receive uplink communications through transceiver 1001 from one or more mobile terminals or mobile UEs over a radio interface. Similarly, processing circuitry 1003 may control network interface 1007 to transmit communications through network interface 1007 to one or more other network nodes and/or to receive communications through network interface from one or more other network nodes. Moreover, modules may be stored in memory 1005, and these modules may provide instructions so that when instructions of a module are executed by processing circuitry 1003, processing circuitry 1003 performs respective operations (e.g., operations discussed below with respect to some embodiments relating to RAN nodes).

According to some other embodiments, a network node may be implemented as a core network CN node without a transceiver. In such embodiments, transmission to a wireless device UE may be initiated by the network node so that transmission to the wireless device is provided through a network node including a transceiver (e.g., through a base station or RAN node). According to embodiments where the network node is a RAN node including a transceiver, initiating transmission may include transmitting through the transceiver.

FIG. 11 is a block diagram illustrating elements of a core network CN node (e.g., an SMF node, an AMF node, etc.) of a communication network configured to provide cellular communication according to embodiments of inventive concepts. As shown, the CN node may include network interface circuitry 1107 (also referred to as a network interface) configured to provide communications with other nodes of the core network and/or the radio access network RAN. The CN node may also include a processing circuitry 1103 (also referred to as a processor) coupled to the network interface circuitry, and memory circuitry 1105 (also referred to as memory) coupled to the processing circuitry. The memory circuitry 1105 may include computer readable program code that when executed by the processing circuitry 1103 causes the processing circuitry to perform operations according to embodiments disclosed herein. According to other embodiments, processing circuitry 1103 may be defined to include memory so that a separate memory circuitry is not required.

As discussed herein, operations of the CN node may be performed by processing circuitry 1103 and/or network interface circuitry 1107. For example, processing circuitry 1103 may control network interface circuitry 1107 to transmit communications through network interface circuitry 1107 to one or more other network nodes and/or to receive communications through network interface circuitry from one or more other network nodes. Moreover, modules may be stored in memory 1105, and these modules may provide instructions so that when instructions of a module are executed by processing circuitry 1103, processing circuitry 1103 performs respective operations (e.g., operations discussed below with respect to some embodiments relating to core network nodes).

An example simulation comparing the use of a legacy scheduling procedure (“LOpt-1”) and a beam user based (“BUB”) scheduling procedure is described below. In this example, a communications network can include twenty communication devices spread across ten beams. The total number of physical resource blocks (“PRBs”) available can be sixty-six. Each communication device can require twenty PRB at every time unit. The communication devices can move across beam in three patterns: 1) a third of the communication devices can move to the next beam every four time units; 2) a third of the communication devices can move to the next beam every fifteen time units; and 3) a third of the communication devices can move to the next beam every twenty-four time units. This simulation may not consider channel condition or variation in user data requirements.

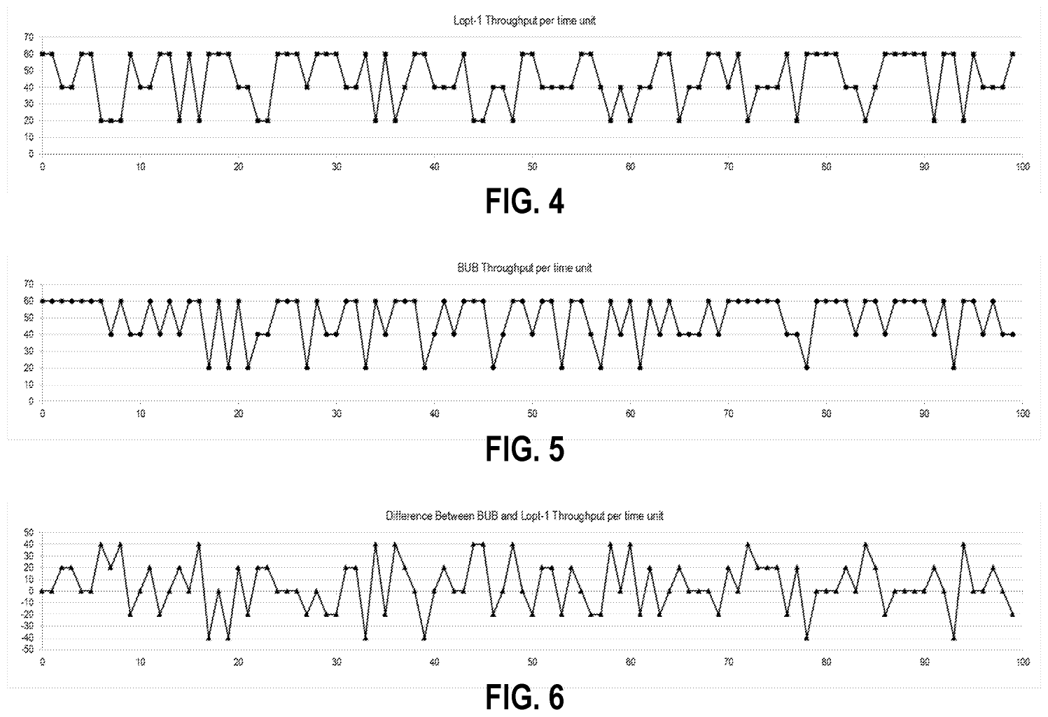

FIG. 4 illustrates an example of throughput per time unit for the LOpt-1, which schedules communication based on how long a communication device has been waiting (e.g., its waiting period). In some embodiments, a further optimization can be performed to schedule all communication devices in a beam once a communication device in the beam is selected based on how long it has waited.

FIG. 5 illustrates an example of throughput per time unit for the BUB scheduling procedure, which can include adding a scheduling weight of up to three points to the legacy scheduler based on a number of communication devices in each beam. In some examples, three points can be added to each waiting factors to determine a scheduling priority associated with a communication device in the beam that has the most communication devices. In additional or alternative examples, two points can be added to each waiting factor associated with a communication device in the beam that has the second most users. In additional or alternative examples, one point can be added to each waiting factor associated with a communication device in the beam that has the third most users. In additional or alternative examples, a communication device with the highest scheduling priority (including both the waiting factor and the points from the number of communication devices in the beam) is selected and then all the user's in the given beam are scheduled.

FIG. 6 illustrates a difference between throughput per time unit using the BUB compared to using LOpt-1. As illustrated, there are many instances when BUB selected a beam with more communication devices in it compared to LOpt-1. In this example, the overall throughput increases by about 10%. Changes in mobility pattern and/or weight will affect the throughput increase.

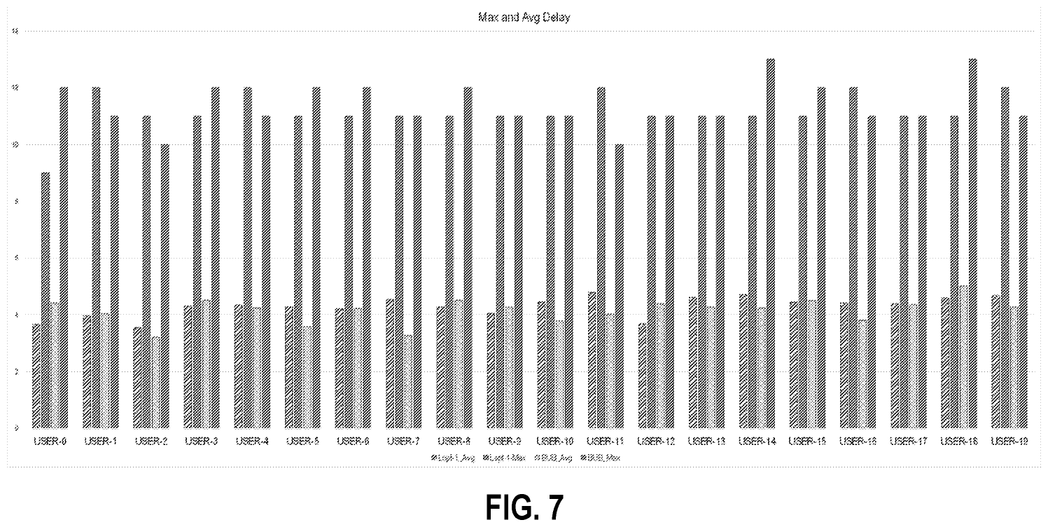

FIG. 7 illustrates a the maximum delay and average delay for each communication device (e.g., user) in the simulation for both the BUB scheduling procedure and the LOpt-1 scheduling procedure. In this example, wait time was not significantly affected. Although, the max wait time for some communication devices went up slightly up in BUB scheduling procedure, the average wait decreased by 3.5% in the BUB scheduling procedure because of the more efficient usage of cell resources.

As used herein, a dense beam refers to a beam which has relatively more communication devices (or users). A sparse beam refers to a beam which has relatively less communication devices (or users). A scheduling weight (also referred to herein as a scheduling priority) refers to weight given to a UE for the purpose of scheduling. A UE with larger scheduling weight is prioritized over a UE with smaller scheduling weight. A legacy scheduling procedure (also referred to as a baseline scheduling procedure) refers to any number of scheduling procedures that are currently being used. A BUB scheduling procedure refers to the scheduling procedures described in some embodiments of the present disclosure. A BUB weight refers to a weight being assigned to a specific communication device (e.g., user-X) based on the number of communication devices in a specific beam (e.g., beam-K) to which the specific communication device belongs. The term, P_ADD, can refer to an operation of the BUB scheduling procedure that results in increased priority. In some examples, P_ADD is a mathematical addition operation. In other examples, P_ADD is a mathematical multiplication operation or another operation.

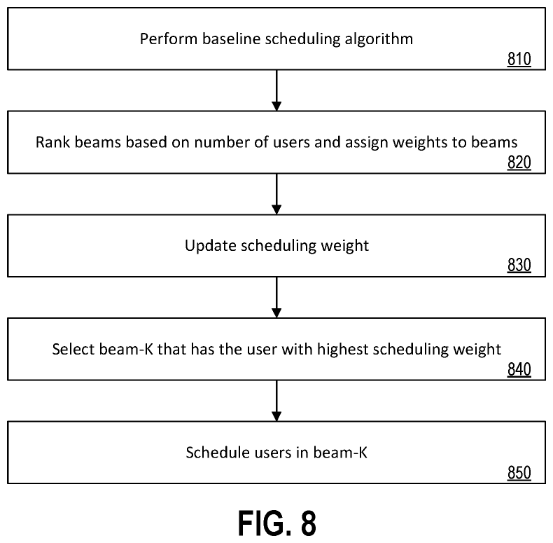

FIG. 8 illustrates an example of operations in a BUB scheduling procedure. The BUB scheduling procedure can be implemented on top of an existing baseline scheduling procedure.

At block 810, the existing baseline scheduling procedure (or legacy scheduling procedure) may first assign a scheduling weight—Wb(i)—to users or communication devices based on a waiting period, QoS, channel condition, or another characteristic or the communication network.

At block 820, all of the beams (which can be referred to as Ntot_beams) are ranked in an order of the number of users or communication devices that are in each beam.

At block 830, scheduling weights associated with some of the communication devices are updated based on the number of communication devices in their corresponding beam. For example, a number of ranked beams (which can be referred to as Nranked_beams) can be selected from the top of the ranked list (those with the most users in it). The set of ranked beams can be represented by Branked(n), where n is greater than or equal to one and less than or equal to Nranked_beams. For example, the number of users in Branked(j) is greater than or equal to the number of users in Branked(k) if j<k. A BUB beam scheduling weight (which can be referred to as Wbub_beam(n)) can be assigned to each beam in the ranked set in decreasing order. For example, Wbub_beam(j)>Wbub_beam(k) if j<k. The BUB user scheduling weight (which can be referred to as Wbub_user(i)) can be computed for each user i. For each user x in a ranked beam Branked(j), the BUB scheduling weight can be calculated (or updated) by P_ADDing the BUB beam weight (Wbub_beam(j)) to user's scheduling Wb(x). For example, Wbub_user(x)=P_ADD(Wb(x)+Wbub_beam(j)). For all other users y, the BUB scheduling weight is the same as the baseline scheduling weight. For example, Wbub_user(y)=Wb(y).

At block 840, beam-K is selected has having the user with the highest scheduling weight. In some examples, beam-K is selected by ranking users in order of BUB user scheduling weight (Wbub_user(i)); picking user X with the highest BUB user scheduling weight, and determining that beam K is associated with user X.

At block 850, all users in beam K starting with user X and in decreasing order of baseline scheduling weight Wb(i) are scheduled until all resources are exhausted. In some embodiments, if there are resources left after scheduling all UEs in beam K, a next beam is selected based on the next beam having the user with the highest scheduling priority. All users in the next beam starting with the user having the highest scheduling priority (and in decreasing order of scheduling priority) are scheduled until all resources are exhausted or a max number of beams are reached. In additional or alternative embodiments, this occurs for hybrid beams in which more than one beam can be supported.

In some embodiments, after scheduling the users in beam-K, the scheduling weights are reset according to the baseline scheduling procedure. For example, if the baseline scheduling procedure uses waiting period, it can be reset after a user has been scheduled.

In one example, three UEs are in two different beams. All UEs require X PRBs. A first UE (“UE-1”) is in a first beam (“beam-1”) with the highest scheduling priority (e.g., a longest wait time). A second UE (“UE-2”) and a third UE (“UE-3”) are in a second beam (“beam-2”) with a scheduling priority of UE-2 being greater than a scheduling priority of UE-3.

Based on this example, an optimized legacy scheduler may schedule UE-1 during a first slot. Before a second slot UE-3 may move to beam-1. Then the optimized legacy scheduler may schedule UE-2 in the second slot.

Based on this example, a BUB scheduler may add beam weights to all UEs based on the number of UEs in their corresponding beams, determine that UE-2 has the highest updated scheduling priority, and schedule UE-2 and UE-3 in beam-2 during the first slot. Before a second slot UE-3 may move to beam-1. Then the BUB scheduler may update scheduling weights based on the number of UEs in their corresponding beams, determine that UE-1 has the highest updated scheduling priority, and schedule UE-1 and UE-3 in beam-1 during the second slot.

In this example, due to UE mobility, the BUB scheduler ends up scheduling 4*X PRBs in two slots while the optimized legacy scheduler only schedules 2*X PRBs.

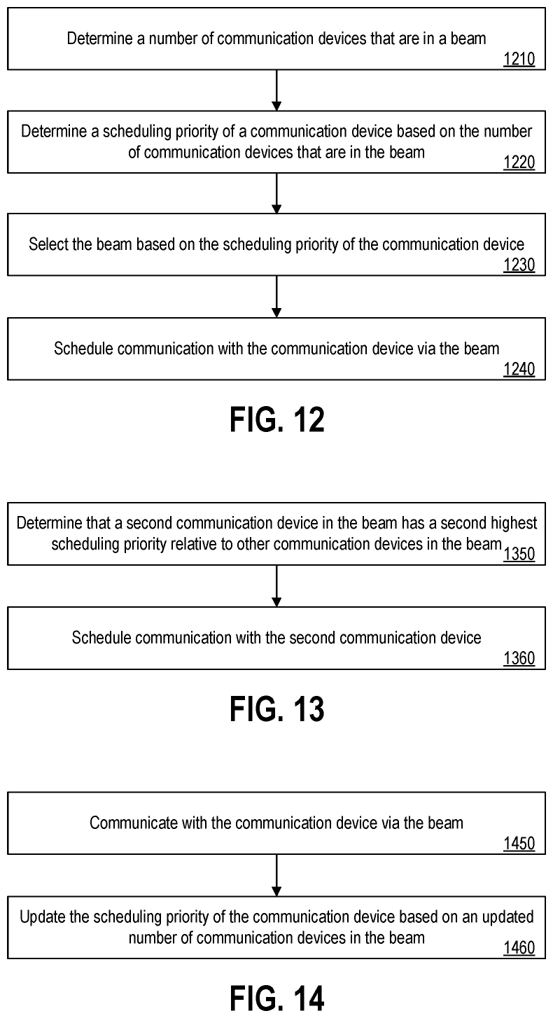

Operations of a network node (implemented using the structure of the block diagram of FIG. 10 will now be discussed with reference to the flow charts of FIGS. 12-14 according to some embodiments of inventive concepts. For example, modules may be stored in memory 1005 of FIG. 10, and these modules may provide instructions so that when the instructions of a module are executed by respective RAN processing circuitry 1003, processing circuitry 1003 performs respective operations of the flow chart.

FIG. 12 illustrates operations performed by a network node to schedule communication based on a location of the communication devices within a corresponding communication network. The network node can be configured to communicate with multiple communication devices in a communications network via multiple beams.

At block 1210, processing circuitry 1003 determines a number of communication devices that are in a beam. In some embodiments, processing circuitry 1003 determines a number of communication devices that are in each beam of the multiple beams.

At block 1220, processing circuitry 1003 determines a scheduling priority of a communication device in the beam based on the number of communication devices that are in the beam. In some embodiments, processing circuitry 1003 determines a scheduling priority for each communication device based on the number of communication devices in each beam of the multiple beams. In additional or alternative embodiments, determining the scheduling priority of the communication device includes determining that the communication device has a greatest scheduling priority. In additional or alternative embodiments, determining the scheduling priority includes determining the scheduling priority based on the number of communication devices in the beam relative to the number of communication devices in each beam of the multiple beams. In additional or alternative embodiments, determining the scheduling priority of the communication device includes determining that the number of communication devices in the beam is less than a number of communication devices in another beam.

In additional or alternative embodiments, the scheduling priority for each communication device is an updated scheduling priority. Determining the updated scheduling priority for each communication device can include determining an initial scheduling priority for each communication device based on a characteristic other than the number of communication devices that are in each beam. Determining the updated scheduling priority for each communication device can further include determining the updated scheduling priority based on the initial scheduling priority and the number of communication devices that are in each beam. In additional or alternative embodiments, the characteristic includes at least on of: a signal-to-interference ratio; a quality of service requirement, and a cell bandwidth.

In additional or alternative embodiments, determining the updated scheduling priority for each communication device includes determining the updated scheduling priority by combining the initial scheduling priority and a scheduling weight based on the number of communication devices that are in each beam using an operation that results in an increased priority.

In additional or alternative embodiments, determining the scheduling priority for each communication device based on the number of communication devices in each beam includes determining a first ranking of a first beam of the multiple beams. The first ranking can indicate a number of communication devices in the first beam relative to the number of communication devices in each beam of the plurality of beams. Determining the scheduling priority for each communication device based on the number of communication devices in each beam further includes, responsive to determining the first ranking, adjusting a scheduling priority associated with each communication device of the first beam by a first amount based on the first ranking. Determining the scheduling priority for each communication device based on the number of communication devices in each beam further includes, determining a second ranking of a second beam of the plurality of beams, the second ranking indicating a number of communication devices in the second beam relative to the number of communication devices in each beam of the plurality of beams. Determining the scheduling priority for each communication device based on the number of communication devices in each beam further includes, responsive to determining the second ranking, determining a scheduling priority for each communication device of the second beam based on the second ranking.

At block 1230, processing circuitry 1003 selects the beam based on the scheduling priority of the communication device. In some embodiments, selecting the beam includes selecting the beam based on determining that the communication device has the greatest scheduling priority.

At block 1240, processing circuitry 1003 schedules communication with the communication device via the beam.

FIG. 13 illustrates operations performed by the network node to schedule communication with a second communication device in the beam.

At block 1350, processing circuitry 1003 determines that a second communication device in the beam has a second highest scheduling priority relative to the other communication devices in the beam. At block 1360, processing circuitry 1003 schedules communication with the second communication device.

FIG. 14 illustrates operations performed by the network node to communicate with the communication device and prepare for subsequent scheduling.

At block 1450, processing circuitry 1003 communicates, via transceiver 1001, with the communication device via the beam. In some embodiments, all communication devices in the beam starting with the communication device with the highest scheduling priority and in decreasing order of scheduling weight and/or a baseline scheduling weight are scheduled until all resources are exhausted. In some embodiments, this operation can be repeated for multiple beams if there are resources left after scheduling all UEs in beam K. For example, a next beam can be selected based on the next beam having the user with the highest scheduling priority. All users in the next beam starting with the user having the highest scheduling priority (and in decreasing order of scheduling priority) are scheduled until all resources are exhausted or a max number of beams are reached. In additional or alternative embodiments, this occurs for hybrid beams in which more than one beam can be supported.

At block 1460, processing circuitry 1003 updates the scheduling priority of the communication device based on an updated number of communication devices in the beam. In some embodiments, the scheduling priorities of all communication devices are reset and/or the effects on the scheduling priorities of the number of communication devices that were in each of the beams is removed. An updated number of communication devices that are in each beam (which may be changed based on the mobility of communication devices) may be determined, and updated scheduling priorities for each communication device can be determined based on the up[dated number of communication devices that are in each beam.

Various operations from the flow charts of FIGS. 12-14 may be optional with respect to some embodiments of network nodes and related methods. For example, in regards to some embodiments, blocks 1350 and 1360 of FIG. 13 and blocks 1450 and 1460 of FIG. 14 may be optional.

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

FIG. 15 illustrates a wireless network in accordance with some embodiments.

Although the subject matter described herein may be implemented in any appropriate type of system using any suitable components, the embodiments disclosed herein are described in relation to a wireless network, such as the example wireless network illustrated in FIG. 15. For simplicity, the wireless network of FIG. 15 only depicts network 4106, network nodes 4160 and 4160b, and WDs 4110, 4110b, and 4110c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 4160 and wireless device (WD) 4110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 4106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 4160 and WD 4110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 15, network node 4160 includes processing circuitry 4170, device readable medium 4180, interface 4190, auxiliary equipment 4184, power source 4186, power circuitry 4187, and antenna 4162. Although network node 4160 illustrated in the example wireless network of FIG. 15 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 4160 are depicted as single boxes located within a larger box, or nested within multiple boxes, in practice, a network node may comprise multiple different physical components that make up a single illustrated component (e.g., device readable medium 4180 may comprise multiple separate hard drives as well as multiple RAM modules).

Similarly, network node 4160 may be composed of multiple physically separate components (e.g., a NodeB component and a RNC component, or a BTS component and a BSC component, etc.), which may each have their own respective components. In certain scenarios in which network node 4160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 4160 may be configured to support multiple radio access technologies (RATs). In such embodiments, some components may be duplicated (e.g., separate device readable medium 4180 for the different RATs) and some components may be reused (e.g., the same antenna 4162 may be shared by the RATs). Network node 4160 may also include multiple sets of the various illustrated components for different wireless technologies integrated into network node 4160, such as, for example, GSM, WCDMA, LTE, NR, WiFi, or Bluetooth wireless technologies. These wireless technologies may be integrated into the same or different chip or set of chips and other components within network node 4160.

Processing circuitry 4170 is configured to perform any determining, calculating, or similar operations (e.g., certain obtaining operations) described herein as being provided by a network node. These operations performed by processing circuitry 4170 may include processing information obtained by processing circuitry 4170 by, for example, converting the obtained information into other information, comparing the obtained information or converted information to information stored in the network node, and/or performing one or more operations based on the obtained information or converted information, and as a result of said processing making a determination.

Processing circuitry 4170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 4160 components, such as device readable medium 4180, network node 4160 functionality. For example, processing circuitry 4170 may execute instructions stored in device readable medium 4180 or in memory within processing circuitry 4170. Such functionality may include providing any of the various wireless features, functions, or benefits discussed herein. In some embodiments, processing circuitry 4170 may include a system on a chip (SOC).

In some embodiments, processing circuitry 4170 may include one or more of radio frequency (RF) transceiver circuitry 4172 and baseband processing circuitry 4174. In some embodiments, radio frequency (RF) transceiver circuitry 4172 and baseband processing circuitry 4174 may be on separate chips (or sets of chips), boards, or units, such as radio units and digital units. In alternative embodiments, part or all of RF transceiver circuitry 4172 and baseband processing circuitry 4174 may be on the same chip or set of chips, boards, or units

In certain embodiments, some or all of the functionality described herein as being provided by a network node, base station, eNB or other such network device may be performed by processing circuitry 4170 executing instructions stored on device readable medium 4180 or memory within processing circuitry 4170. In alternative embodiments, some or all of the functionality may be provided by processing circuitry 4170 without executing instructions stored on a separate or discrete device readable medium, such as in a hard-wired manner. In any of those embodiments, whether executing instructions stored on a device readable storage medium or not, processing circuitry 4170 can be configured to perform the described functionality. The benefits provided by such functionality are not limited to processing circuitry 4170 alone or to other components of network node 4160, but are enjoyed by network node 4160 as a whole, and/or by end users and the wireless network generally.

Device readable medium 4180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 4170. Device readable medium 4180 may store any suitable instructions, data or information, including a computer program, software, an application including one or more of logic, rules, code, tables, etc. and/or other instructions capable of being executed by processing circuitry 4170 and, utilized by network node 4160. Device readable medium 4180 may be used to store any calculations made by processing circuitry 4170 and/or any data received via interface 4190. In some embodiments, processing circuitry 4170 and device readable medium 4180 may be considered to be integrated.

Interface 4190 is used in the wired or wireless communication of signalling and/or data between network node 4160, network 4106, and/or WDs 4110. As illustrated, interface 4190 comprises port(s)/terminal(s) 4194 to send and receive data, for example to and from network 4106 over a wired connection. Interface 4190 also includes radio front end circuitry 4192 that may be coupled to, or in certain embodiments a part of, antenna 4162. Radio front end circuitry 4192 comprises filters 4198 and amplifiers 4196. Radio front end circuitry 4192 may be connected to antenna 4162 and processing circuitry 4170. Radio front end circuitry may be configured to condition signals communicated between antenna 4162 and processing circuitry 4170. Radio front end circuitry 4192 may receive digital data that is to be sent out to other network nodes or WDs via a wireless connection. Radio front end circuitry 4192 may convert the digital data into a radio signal having the appropriate channel and bandwidth parameters using a combination of filters 4198 and/or amplifiers 4196. The radio signal may then be transmitted via antenna 4162. Similarly, when receiving data, antenna 4162 may collect radio signals which are then converted into digital data by radio front end circuitry 4192. The digital data may be passed to processing circuitry 4170. In other embodiments, the interface may comprise different components and/or different combinations of components.

In certain alternative embodiments, network node 4160 may not include separate radio front end circuitry 4192, instead, processing circuitry 4170 may comprise radio front end circuitry and may be connected to antenna 4162 without separate radio front end circuitry 4192. Similarly, in some embodiments, all or some of RF transceiver circuitry 4172 may be considered a part of interface 4190. In still other embodiments, interface 4190 may include one or more ports or terminals 4194, radio front end circuitry 4192, and RF transceiver circuitry 4172, as part of a radio unit (not shown), and interface 4190 may communicate with baseband processing circuitry 4174, which is part of a digital unit (not shown).

Antenna 4162 may include one or more antennas, or antenna arrays, configured to send and/or receive wireless signals. Antenna 4162 may be coupled to radio front end circuitry 4192 and may be any type of antenna capable of transmitting and receiving data and/or signals wirelessly. In some embodiments, antenna 4162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as M IMO. In certain embodiments, antenna 4162 may be separate from network node 4160 and may be connectable to network node 4160 through an interface or port.

Antenna 4162, interface 4190, and/or processing circuitry 4170 may be configured to perform any receiving operations and/or certain obtaining operations described herein as being performed by a network node. Any information, data and/or signals may be received from a wireless device, another network node and/or any other network equipment. Similarly, antenna 4162, interface 4190, and/or processing circuitry 4170 may be configured to perform any transmitting operations described herein as being performed by a network node. Any information, data and/or signals may be transmitted to a wireless device, another network node and/or any other network equipment.

Power circuitry 4187 may comprise, or be coupled to, power management circuitry and is configured to supply the components of network node 4160 with power for performing the functionality described herein. Power circuitry 4187 may receive power from power source 4186. Power source 4186 and/or power circuitry 4187 may be configured to provide power to the various components of network node 4160 in a form suitable for the respective components (e.g., at a voltage and current level needed for each respective component). Power source 4186 may either be included in, or external to, power circuitry 4187 and/or network node 4160. For example, network node 4160 may be connectable to an external power source (e.g., an electricity outlet) via an input circuitry or interface such as an electrical cable, whereby the external power source supplies power to power circuitry 4187. As a further example, power source 4186 may comprise a source of power in the form of a battery or battery pack which is connected to, or integrated in, power circuitry 4187. The battery may provide backup power should the external power source fail. Other types of power sources, such as photovoltaic devices, may also be used.

Alternative embodiments of network node 4160 may include additional components beyond those shown in FIG. 15 that may be responsible for providing certain aspects of the network node's functionality, including any of the functionality described herein and/or any functionality necessary to support the subject matter described herein. For example, network node 4160 may include user interface equipment to allow input of information into network node 4160 and to allow output of information from network node 4160. This may allow a user to perform diagnostic, maintenance, repair, and other administrative functions for network node 4160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 4110 includes antenna 4111, interface 4114, processing circuitry 4120, device readable medium 4130, user interface equipment 4132, auxiliary equipment 4134, power source 4136 and power circuitry 4137. WD 4110 may include multiple sets of one or more of the illustrated components for different wireless technologies supported by WD 4110, such as, for example, GSM, WCDMA, LTE, NR, WiFi, VViMAX, or Bluetooth wireless technologies, just to mention a few. These wireless technologies may be integrated into the same or different chips or set of chips as other components within WD 4110.

Antenna 4111 may include one or more antennas or antenna arrays, configured to send and/or receive wireless signals, and is connected to interface 4114. In certain alternative embodiments, antenna 4111 may be separate from WD 4110 and be connectable to WD 4110 through an interface or port. Antenna 4111, interface 4114, and/or processing circuitry 4120 may be configured to perform any receiving or transmitting operations described herein as being performed by a WD. Any information, data and/or signals may be received from a network node and/or another WD. In some embodiments, radio front end circuitry and/or antenna 4111 may be considered an interface.

As illustrated, interface 4114 comprises radio front end circuitry 4112 and antenna 4111. Radio front end circuitry 4112 comprise one or more filters 4118 and amplifiers 4116. Radio front end circuitry 4112 is connected to antenna 4111 and processing circuitry 4120, and is configured to condition signals communicated between antenna 4111 and processing circuitry 4120. Radio front end circuitry 4112 may be coupled to or a part of antenna 4111. In some embodiments, WD 4110 may not include separate radio front end circuitry 4112; rather, processing circuitry 4120 may comprise radio front end circuitry and may be connected to antenna 4111. Similarly, in some embodiments, some or all of RF transceiver circuitry 4122 may be considered a part of interface 4114. Radio front end circuitry 4112 may receive digital data that is to be sent out to other network nodes or WDs via a wireless connection. Radio front end circuitry 4112 may convert the digital data into a radio signal having the appropriate channel and bandwidth parameters using a combination of filters 4118 and/or amplifiers 4116. The radio signal may then be transmitted via antenna 4111. Similarly, when receiving data, antenna 4111 may collect radio signals which are then converted into digital data by radio front end circuitry 4112. The digital data may be passed to processing circuitry 4120. In other embodiments, the interface may comprise different components and/or different combinations of components.

Processing circuitry 4120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 4110 components, such as device readable medium 4130, WD 4110 functionality. Such functionality may include providing any of the various wireless features or benefits discussed herein. For example, processing circuitry 4120 may execute instructions stored in device readable medium 4130 or in memory within processing circuitry 4120 to provide the functionality disclosed herein.

As illustrated, processing circuitry 4120 includes one or more of RF transceiver circuitry 4122, baseband processing circuitry 4124, and application processing circuitry 4126. In other embodiments, the processing circuitry may comprise different components and/or different combinations of components. In certain embodiments processing circuitry 4120 of WD 4110 may comprise a SOC. In some embodiments, RF transceiver circuitry 4122, baseband processing circuitry 4124, and application processing circuitry 4126 may be on separate chips or sets of chips. In alternative embodiments, part or all of baseband processing circuitry 4124 and application processing circuitry 4126 may be combined into one chip or set of chips, and RF transceiver circuitry 4122 may be on a separate chip or set of chips. In still alternative embodiments, part or all of RF transceiver circuitry 4122 and baseband processing circuitry 4124 may be on the same chip or set of chips, and application processing circuitry 4126 may be on a separate chip or set of chips. In yet other alternative embodiments, part or all of RF transceiver circuitry 4122, baseband processing circuitry 4124, and application processing circuitry 4126 may be combined in the same chip or set of chips. In some embodiments, RF transceiver circuitry 4122 may be a part of interface 4114. RF transceiver circuitry 4122 may condition RF signals for processing circuitry 4120.

In certain embodiments, some or all of the functionality described herein as being performed by a WD may be provided by processing circuitry 4120 executing instructions stored on device readable medium 4130, which in certain embodiments may be a computer-readable storage medium. In alternative embodiments, some or all of the functionality may be provided by processing circuitry 4120 without executing instructions stored on a separate or discrete device readable storage medium, such as in a hard-wired manner. In any of those particular embodiments, whether executing instructions stored on a device readable storage medium or not, processing circuitry 4120 can be configured to perform the described functionality. The benefits provided by such functionality are not limited to processing circuitry 4120 alone or to other components of WD 4110, but are enjoyed by WD 4110 as a whole, and/or by end users and the wireless network generally.

Processing circuitry 4120 may be configured to perform any determining, calculating, or similar operations (e.g., certain obtaining operations) described herein as being performed by a WD. These operations, as performed by processing circuitry 4120, may include processing information obtained by processing circuitry 4120 by, for example, converting the obtained information into other information, comparing the obtained information or converted information to information stored by WD 4110, and/or performing one or more operations based on the obtained information or converted information, and as a result of said processing making a determination.

Device readable medium 4130 may be operable to store a computer program, software, an application including one or more of logic, rules, code, tables, etc. and/or other instructions capable of being executed by processing circuitry 4120. Device readable medium 4130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 4120. In some embodiments, processing circuitry 4120 and device readable medium 4130 may be considered to be integrated.

User interface equipment 4132 may provide components that allow for a human user to interact with WD 4110. Such interaction may be of many forms, such as visual, audial, tactile, etc. User interface equipment 4132 may be operable to produce output to the user and to allow the user to provide input to WD 4110. The type of interaction may vary depending on the type of user interface equipment 4132 installed in WD 4110. For example, if WD 4110 is a smart phone, the interaction may be via a touch screen; if WD 4110 is a smart meter, the interaction may be through a screen that provides usage (e.g., the number of gallons used) or a speaker that provides an audible alert (e.g., if smoke is detected). User interface equipment 4132 may include input interfaces, devices and circuits, and output interfaces, devices and circuits. User interface equipment 4132 is configured to allow input of information into WD 4110, and is connected to processing circuitry 4120 to allow processing circuitry 4120 to process the input information. User interface equipment 4132 may include, for example, a microphone, a proximity or other sensor, keys/buttons, a touch display, one or more cameras, a USB port, or other input circuitry. User interface equipment 4132 is also configured to allow output of information from WD 4110, and to allow processing circuitry 4120 to output information from WD 4110. User interface equipment 4132 may include, for example, a speaker, a display, vibrating circuitry, a USB port, a headphone interface, or other output circuitry. Using one or more input and output interfaces, devices, and circuits, of user interface equipment 4132, WD 4110 may communicate with end users and/or the wireless network, and allow them to benefit from the functionality described herein.

Auxiliary equipment 4134 is operable to provide more specific functionality which may not be generally performed by WDs. This may comprise specialized sensors for doing measurements for various purposes, interfaces for additional types of communication such as wired communications etc. The inclusion and type of components of auxiliary equipment 4134 may vary depending on the embodiment and/or scenario.

Power source 4136 may, in some embodiments, be in the form of a battery or battery pack. Other types of power sources, such as an external power source (e.g., an electricity outlet), photovoltaic devices or power cells, may also be used. WD 4110 may further comprise power circuitry 4137 for delivering power from power source 4136 to the various parts of WD 4110 which need power from power source 4136 to carry out any functionality described or indicated herein. Power circuitry 4137 may in certain embodiments comprise power management circuitry. Power circuitry 4137 may additionally or alternatively be operable to receive power from an external power source; in which case WD 4110 may be connectable to the external power source (such as an electricity outlet) via input circuitry or an interface such as an electrical power cable. Power circuitry 4137 may also in certain embodiments be operable to deliver power from an external power source to power source 4136. This may be, for example, for the charging of power source 4136. Power circuitry 4137 may perform any formatting, converting, or other modification to the power from power source 4136 to make the power suitable for the respective components of WD 4110 to which power is supplied.

FIG. 16 illustrates a user Equipment in accordance with some embodiments.

FIG. 16 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 42200 may be any UE identified by the 3rd Generation Partnership Project (3GPP), including a NB-IoT UE, a machine type communication (MTC) UE, and/or an enhanced MTC (eMTC) UE. UE 4200, as illustrated in FIG. 16, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 16 is a UE, the components discussed herein are equally applicable to a WD, and vice-versa.

In FIG. 16, UE 4200 includes processing circuitry 4201 that is operatively coupled to input/output interface 4205, radio frequency (RF) interface 4209, network connection interface 4211, memory 4215 including random access memory (RAM) 4217, read-only memory (ROM) 4219, and storage medium 4221 or the like, communication subsystem 4231, power source 4213, and/or any other component, or any combination thereof. Storage medium 4221 includes operating system 4223, application program 4225, and data 4227. In other embodiments, storage medium 4221 may include other similar types of information. Certain UEs may utilize all of the components shown in FIG. 16, or only a subset of the components. The level of integration between the components may vary from one UE to another UE. Further, certain UEs may contain multiple instances of a component, such as multiple processors, memories, transceivers, transmitters, receivers, etc.

In FIG. 16, processing circuitry 4201 may be configured to process computer instructions and data. Processing circuitry 4201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 4201 may include two central processing units (CPUs). Data may be information in a form suitable for use by a computer.

In the depicted embodiment, input/output interface 4205 may be configured to provide a communication interface to an input device, output device, or input and output device. UE 4200 may be configured to use an output device via input/output interface 4205. An output device may use the same type of interface port as an input device. For example, a USB port may be used to provide input to and output from UE 4200. The output device may be a speaker, a sound card, a video card, a display, a monitor, a printer, an actuator, an emitter, a smartcard, another output device, or any combination thereof. UE 4200 may be configured to use an input device via input/output interface 4205 to allow a user to capture information into UE 4200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 16, RF interface 4209 may be configured to provide a communication interface to RF components such as a transmitter, a receiver, and an antenna. Network connection interface 4211 may be configured to provide a communication interface to network 4243a. Network 4243a may encompass wired and/or wireless networks such as a local-area network (LAN), a wide-area network (WAN), a computer network, a wireless network, a telecommunications network, another like network or any combination thereof. For example, network 4243a may comprise a Wi-Fi network. Network connection interface 4211 may be configured to include a receiver and a transmitter interface used to communicate with one or more other devices over a communication network according to one or more communication protocols, such as Ethernet, TCP/IP, SONET, ATM, or the like. Network connection interface 4211 may implement receiver and transmitter functionality appropriate to the communication network links (e.g., optical, electrical, and the like). The transmitter and receiver functions may share circuit components, software or firmware, or alternatively may be implemented separately.

RAM 4217 may be configured to interface via bus 4202 to processing circuitry 4201 to provide storage or caching of data or computer instructions during the execution of software programs such as the operating system, application programs, and device drivers. ROM 4219 may be configured to provide computer instructions or data to processing circuitry 4201. For example, ROM 4219 may be configured to store invariant low-level system code or data for basic system functions such as basic input and output (I/O), startup, or reception of keystrokes from a keyboard that are stored in a non-volatile memory. Storage medium 4221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 4221 may be configured to include operating system 4223, application program 4225 such as a web browser application, a widget or gadget engine or another application, and data file 4227. Storage medium 4221 may store, for use by UE 4200, any of a variety of various operating systems or combinations of operating systems.

Storage medium 4221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 4221 may allow UE 4200 to access computer-executable instructions, application programs or the like, stored on transitory or non-transitory memory media, to off-load data, or to upload data. An article of manufacture, such as one utilizing a communication system may be tangibly embodied in storage medium 4221, which may comprise a device readable medium.

In FIG. 16, processing circuitry 4201 may be configured to communicate with network 4243b using communication subsystem 4231. Network 4243a and network 4243b may be the same network or networks or different network or networks. Communication subsystem 4231 may be configured to include one or more transceivers used to communicate with network 4243b. For example, communication subsystem 4231 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 4233 and/or receiver 4235 to implement transmitter or receiver functionality, respectively, appropriate to the RAN links (e.g., frequency allocations and the like). Further, transmitter 4233 and receiver 4235 of each transceiver may share circuit components, software or firmware, or alternatively may be implemented separately.

In the illustrated embodiment, the communication functions of communication subsystem 4231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 4231 may include cellular communication, Wi-Fi communication, Bluetooth communication, and GPS communication. Network 4243b may encompass wired and/or wireless networks such as a local-area network (LAN), a wide-area network (WAN), a computer network, a wireless network, a telecommunications network, another like network or any combination thereof. For example, network 4243b may be a cellular network, a Wi-Fi network, and/or a near-field network. Power source 4213 may be configured to provide alternating current (AC) or direct current (DC) power to components of UE 4200.

The features, benefits and/or functions described herein may be implemented in one of the components of UE 4200 or partitioned across multiple components of UE 4200. Further, the features, benefits, and/or functions described herein may be implemented in any combination of hardware, software or firmware. In one example, communication subsystem 4231 may be configured to include any of the components described herein. Further, processing circuitry 4201 may be configured to communicate with any of such components over bus 4202. In another example, any of such components may be represented by program instructions stored in memory that when executed by processing circuitry 4201 perform the corresponding functions described herein. In another example, the functionality of any of such components may be partitioned between processing circuitry 4201 and communication subsystem 4231. In another example, the non-computationally intensive functions of any of such components may be implemented in software or firmware and the computationally intensive functions may be implemented in hardware.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method of operating a network node configured to communicate with a plurality of communication devices in a communications network via a plurality of beams, the method comprising:
determining a number of communication devices of the plurality of communication devices that are in a beam of the plurality of beams;
determining a scheduling priority of a communication device of the plurality of communication devices based on the number of communication devices that are in the beam, the communication device being in the beam;
selecting the beam based on the scheduling priority of the communication device; and
responsive to selecting the beam, scheduling communication with the communication device via the beam.

2. The method of claim 1, wherein the number of communication devices of the plurality of communication devices that are in the beam of the plurality of beams is a first number,
wherein the scheduling priority of the communication device of the plurality of communication devices is a first scheduling priority,
wherein determining the first number comprises determining a number of communication devices of the plurality of communication devices that are in each beam of the plurality of beams, and
wherein determining the first scheduling priority comprises determining a scheduling priority for each communication device of the plurality of communication devices based on the number of communication devices in each beam of the plurality of beams.

3. The method of claim 2, wherein determining the first scheduling priority further comprises determining that the communication device has a greatest scheduling priority, and
wherein selecting the beam comprises selecting the beam based on determining that the communication device has the greatest scheduling priority.

4. The method of claim 2, wherein determining the first scheduling priority further comprises determining the first scheduling priority based on the number of communication devices in the beam relative to the number of communication devices in each beam of the plurality of beams.

5. The method of claim 4, wherein determining the first scheduling priority further comprises determining that the number of communication devices of the plurality of communication devices in the beam is less than a number of communication devices of the plurality of communication devices in another beam of the plurality of beams.

6. The method of claim 1, wherein the communication device is a first communication device,
the method further comprising:
determining that a second communication device in the beam has a second highest scheduling priority of scheduling priorities relative to scheduling priorities associated with communication devices in the beam; and
responsive to scheduling the communication with the first communication device, scheduling communication with the second communication device via the beam based on the second communication device having the second highest scheduling priority of scheduling priorities relative to the scheduling priorities associated with communication devices in the beam.

7. The method of claim 2, wherein the scheduling priority for each communication device is an updated scheduling priority,
wherein determining the updated scheduling priority for each communication device of the plurality of communication devices comprises:
determining an initial scheduling priority for each communication device of the plurality of communication devices based on a characteristic other than the number of communication devices that are in each beam; and
determining the updated scheduling priority for each communication device of the plurality of communication devices based on the initial scheduling priority and the number of communication devices that are in each beam.

8. The method of claim 7, wherein the characteristic comprises at least one of: a signal-to-interference ratio; a quality of service requirement, a cell bandwidth; and a waiting period of each communication device of the plurality of communication devices.

9. The method of claim 7, wherein determining the updated scheduling priority for each communication device of the plurality of communication devices comprises:
determining a beam-user-based (“BUB”) scheduling priority based on the number of communication devices that are in each beam; and
determining the updated scheduling priority for each communication device of the plurality of communication devices by combining the initial scheduling priority and the BUB scheduling priority using an operation that results in an increased priority.

10. The method of claim 2, wherein determining the scheduling priority for each communication device of the plurality of communication devices based on the number of communication devices in each beam of the plurality of beams comprises:
determining a first ranking of a first beam of the plurality of beams, the first ranking indicating a number of communication devices in the first beam relative to the number of communication devices in each beam of the plurality of beams;
responsive to determining the first ranking, adjusting a scheduling priority associated with each communication device of the first beam by a first amount based on the first ranking;
determining a second ranking of a second beam of the plurality of beams, the second ranking indicating a number of communication devices in the second beam relative to the number of communication devices in each beam of the plurality of beams; and
responsive to determining the second ranking, determining a scheduling priority for each communication device of the second beam based on the second ranking.

11. The method of claim 1, further comprising:
responsive to scheduling the communication with the communication device via the beam, communicating with the communication device via the beam.

12. The method of claim 11, further comprising:
responsive to communicating with the communication device via the beam, updating the scheduling priority of the communication device based on an updated number of communication devices in the beam relative to an updated number of communication devices in each beam of the plurality of beams.

13. A network node configured to communicate with a plurality of communication devices in a communications network via a plurality of beams, the network node comprising:
processing circuitry; and
memory coupled to the processing circuitry and having instructions stored therein that are executable by the processing circuitry to cause the network node to perform operations comprising:
determining a number of communication devices of the plurality of communication devices that are in a beam of the plurality of beams;
determining a scheduling priority of a communication device of the plurality of communication devices based on the number of communication devices that are in the beam, the communication device being in the beam;
selecting the beam based on the scheduling priority of the communication device; and
responsive to selecting the beam, scheduling communication with the communication device via the beam.

14. The network node of claim 13, wherein the number of communication devices of the plurality of communication devices that are in the beam of the plurality of beams is a first number,
wherein the scheduling priority of the communication device of the plurality of communication devices is a first scheduling priority,
wherein determining the first number comprises determining a number of communication devices of the plurality of communication devices that are in each beam of the plurality of beams, and
wherein determining the first scheduling priority comprises determining a scheduling priority for each communication device of the plurality of communication devices based on the number of communication devices in each beam of the plurality of beams.

15. A network node configured to communicate with a plurality of communication devices in a communications network via a plurality of beams, the network node adapted to perform operations comprising:
determining a number of communication devices of the plurality of communication devices that are in a beam of the plurality of beams;
determining a scheduling priority of a communication device of the plurality of communication devices based on the number of communication devices that are in the beam, the communication device being in the beam;
selecting the beam based on the scheduling priority of the communication device; and
responsive to selecting the beam, scheduling communication with the communication device via the beam.

16. The network node of claim 15, wherein the number of communication devices of the plurality of communication devices that are in the beam of the plurality of beams is a first number,
wherein the scheduling priority of the communication device of the plurality of communication devices is a first scheduling priority,
wherein determining the first number comprises determining a number of communication devices of the plurality of communication devices that are in each beam of the plurality of beams, and
wherein determining the first scheduling priority comprises determining a scheduling priority for each communication device of the plurality of communication devices based on the number of communication devices in each beam of the plurality of beams.

17. A computer program comprising program code to be executed by processing circuitry of a network node configured to communicate with a plurality of communication devices in a communications network via a plurality of beams, whereby execution of the program code causes the network node to perform operations comprising:
determining a number of communication devices of the plurality of communication devices that are in a beam of the plurality of beams;
determining a scheduling priority of a communication device of the plurality of communication devices based on the number of communication devices that are in the beam, the communication device being in the beam;
selecting the beam based on the scheduling priority of the communication device; and
responsive to selecting the beam, scheduling communication with the communication device via the beam.

18. The computer program of claim 17, wherein the number of communication devices of the plurality of communication devices that are in the beam of the plurality of beams is a first number,
wherein the scheduling priority of the communication device of the plurality of communication devices is a first scheduling priority,
wherein determining the first number comprises determining a number of communication devices of the plurality of communication devices that are in each beam of the plurality of beams, and
wherein determining the first scheduling priority comprises determining a scheduling priority for each communication device of the plurality of communication devices based on the number of communication devices in each beam of the plurality of beams.

19-20. (canceled)

21. The computer program of claim 17, wherein determining the first scheduling priority further comprises determining that the communication device has a greatest scheduling priority, and
wherein selecting the beam comprises selecting the beam based on determining that the communication device has the greatest scheduling priority.

21. The computer program of claim 21, wherein determining the first scheduling priority further comprises determining the first scheduling priority based on the number of communication devices in the beam relative to the number of communication devices in each beam of the plurality of beams.
